(19) United States
(12) Patent Application Publication
(10) Pub. No.: US 2013/0255387 A1
(43) Pub. Date: Oct. 3, 2013

(54) VIBRATION DEVICE AND METHOD FOR MANUFACTURING VIBRATION DEVICE

(71) Applicant: SEIKO EPSON CORPORATION, Tokyo (JP)

(72) Inventor: Terunao HANAOKA, Fujimi-machi (JP)

(73) Assignee: SEIKO EPSON CORPORATION, Tokyo (JP)

(21) Appl. No.: 13/849,841

(22) Filed: Mar. 25, 2013

(30) Foreign Application Priority Data
Mar. 29, 2012 (JP) 2012-076480

(51) Int. Cl. G01H 17/00

(52) U.S. Cl. CPC G01H 17/00
USPC 73/649; 29/593

(57) ABSTRACT

A vibration device includes: a semiconductor substrate;
a first electrode provided on a first surface of the semiconductor substrate; a protective layer provided on the first surface and covering an end section of the first surface; and a vibration element having a vibration section, a mass adjusting section located on the vibration section and a second electrode. The vibration element is mounted on the first surface with the first electrode and the second electrode connected together, in a manner that the mass adjusting section is located in an area that overlaps the protective layer in a plan view, and a part of the vibration element is disposed at a position that does not overlap the first surface in a plan view.

### TECHNICAL FIELD

The present invention related to vibration devices and methods for manufacturing a vibration device claims a priority based on Japanese Patent Application No. 2012-76480 filed on Mar. 29, 2012, the contents of which are incorporated herein by reference.

### RELATED ART

As one example of sensor devices that detect acceleration and angular velocity, a vibration device that is equipped with a vibration element as a sensor element and a circuit element having the function to drive the vibration element is known. Such a vibration device is described, for example, in JP-A-2011-179941 (Patent Document 1). The vibration device described in Patent Document 1 has a package that contains a gyro vibration member as a vibration element, and a semiconductor substrate provided with circuit elements. The vibration device is configured in such a manner that the vibration element is stacked on the semiconductor substrate. For adjustment of the vibration frequency of the vibration element, a laser beam is used to remove mass adjustment sections (electrodes or the like) provided on the vibration element.

However, the vibration device having such a configuration entails a problem in that the semiconductor substrate may be damaged by the laser beam that has penetrated the vibration element, and is irradiated onto the semiconductor substrate.

### SUMMARY

The invention has been made to solve at least a part of the problem described above, and can be realized by embodiments or application examples to be described below.

### Application Example 1

A vibration device in accordance with an application example of the invention includes a semiconductor substrate, a first electrode provided on a first surface of the semiconductor substrate, a protective layer provided on the first surface and covering an end section of the first surface, and a vibration element having a vibration section, a mass adjusting section located on the vibration section and a second electrode. The vibration element is mounted on the first surface with the first electrode and the second electrode connected together, in a manner that the mass adjusting section is located in an area that overlaps the protective layer in a plan view, and a part of the vibration element is disposed at a position that does not overlap the first surface in a plan view.

According to the vibration device, as seen in a plan view, the vibration element is installed on the semiconductor substrate in a manner that its mass adjusting section overlaps the protective layer provided in the end section of the semiconductor substrate, and a portion of the vibration element does not overlap the semiconductor substrate, in other words, extends outward (overhangs) beyond the end section of the semiconductor substrate. As a result, the area of the semiconductor substrate can be reduced by an amount corresponding to the overhanging surface area of the vibration element, compared with the vibration device of related art in which the vibration element is mounted on the semiconductor substrate. Therefore, the semiconductor substrate can be reduced in size without changing the size of the vibration element.

### Application Example 2

In the vibration device in accordance with an aspect of the application example described above, the protective layer may preferably be formed to have a thickness that becomes thinner toward the end of the semiconductor substrate.

According to the vibration device described above, in a cross-sectional view of the end section of the semiconductor substrate, the protective layer covering the end section of the semiconductor substrate has a slope toward the edge of the semiconductor substrate. As a result, exfoliation between the protective layer and the semiconductor substrate or among layers in the protective layer, which may be caused by stress generated when the protective layer is cut (opened), can be suppressed. Accordingly, the protective layer whose exfoliation is suppressed can be provided in the end section of the semiconductor substrate.

### Application Example 3

In the vibration device in accordance with an aspect of the application example described above, the protective layer may be formed by electroless plating.

According to the vibration device described above, by forming the protective layer by electroless plating, the vibration device can be provided with a protective layer that can control exfoliation between the protective layer and the semiconductor substrate or among layers in the protective layer, which may be caused by stress caused by thermal expansion generated after the protective layer is cut.

### Application Example 4

In accordance with another application example of the invention, there is provided a method for manufacturing a vibration device including a vibration element having a vibration section and a mass adjustment section provided on the vibration section, and a semiconductor substrate having a first surface and a protective layer provided on the first surface and covering an end section of the first surface. The method includes mounting the vibration element over the first surface; positioning the mass adjustment section in an area that overlaps the protective layer in a plan view; disposing a part of the vibration element at a position that does not overlap the first surface; connecting a first electrode provided on the first surface and a second electrode of the vibration element; and, after mounting the vibration element, conducting frequency adjustment by adjusting the mass of the mass adjusting section through irradiating a laser beam at the mass adjusting section of the vibration element so that the vibration section of the vibration element has a specified value of resonance frequency.

According to the method for manufacturing a vibration device, the vibration element is mounted on the semiconductor substrate in a manner that the mass adjusting section provided on the vibration element overlaps the protective layer provided in the end section of the semiconductor substrate, and a portion of the vibration element does not overlap the semiconductor substrate, in other words, extends outward (overhangs) beyond the end section of the semiconductor substrate. As a result, even when the laser beam irradiated at the mass adjusting section of the vibration element in frequency adjustment penetrates the vibration element, the laser beam is blocked by the protective layer provided in the end section of the semiconductor substrate. Therefore, the area of the semiconductor substrate can be reduced by an amount corresponding to the overhanging surface area of the vibration element, compared with the vibration device of related art in which the vibration element is mounted on the semiconductor substrate.

### Application Example 5

The method for manufacturing a vibration device according to the application example described above may further include forming the protective layer, and cutting the protective layer by a bevel cutting method.

According to the method for manufacturing a vibration device described above, the protective layer that covers the end section of the semiconductor substrate is cut by a bevel cutting method. As a result, as seen in a cross-sectional view of the semiconductor substrate, the protective layer having a slope toward the edge of the semiconductor substrate can be obtained. Accordingly, exfoliation between the semiconductor substrate and the protective layer and among layers in the protective layer, which may be caused by stress generated after the protective layer has been cut, can be suppressed. Accordingly, it is possible to provide a protective layer at the end section of the semiconductor substrate because exfoliation of the protective layer from the end section of the semiconductor substrate can be controlled.

### Application Example 6

In the method for manufacturing a vibration device according to the application example described above, the protective layer may be formed to have a thickness that becomes thinner toward the end of the semiconductor substrate, and the frequency adjustment may preferably include irradiating a laser beam in an area between the end section of the semiconductor substrate and a guard ring, as seen in a plan view, that is provided in the semiconductor substrate in a position where the protective layer having a thickness greater than a thickness of the protective layer to be removed by irradiation of the laser beam is located.

There may be cases where the laser beam used in the frequency adjustment is irradiated at a portion of the mass adjusting section which is located in an area where the protective layer has a thickness that is smaller than the thickness of the protective layer to be removed by the laser beam. In this instance, it is possible that the laser beam may penetrate the mass adjusting section and may be irradiated at the protective layer. Even in this case, according to the method for manufacturing a vibration device described above, the guard ring can protect the semiconductor substrate from thermal damage or the like that may be caused by the laser beam. Therefore, the frequency adjusting process using a laser beam, which can suppress damage to the semiconductor substrate, can be performed even in an edge area of the semiconductor substrate where the thickness of the protective layer becomes smaller.

### BRIEF DESCRIPTION OF THE DRAWINGS

FIG. 1 is a plan view schematically showing a vibration device in accordance with an embodiment of the invention.

FIGS. 2A and 2B are cross-sectional views schematically showing the vibration device in accordance with the embodiment.

FIGS. 3A and 3B are cross-sectional views schematically showing a semiconductor substrate of the vibration device in accordance with the embodiment.

FIG. 4 is an illustration for explaining motions of a vibration element in accordance with the embodiment.

FIG. 5 is a flow chart of a process of manufacturing a vibration device in accordance with an embodiment of the invention.

FIGS. 6A and 6B are illustrations for explaining a process of dicing the vibration device in accordance with an embodiment of the invention.

### DESCRIPTION OF EXEMPLARY EMBODIMENTS

An embodiment of the invention will be described with reference to the accompanying drawings. In each of the drawings, the size and the ratio of each component may be illustrated different from those of an actual component as needed, so that each of the components assumes the size to the extent that they can be recognized on the drawings. Moreover, an XYZ orthogonal coordinate system is set in each of the drawings, and the relative position of each component will be described referring to the XYZ orthogonal coordinate system. A predetermined direction in a vertical plane is assumed to be an X-axis direction, a direction orthogonal to the X axis direction in the vertical plane is assumed to be a Y-axis direction, and a direction perpendicular to both of the X-axis direction and the Y-axis direction is assumed to be a Z-axis direction. Also, when the direction of gravity is set as reference, the direction of gravity is assumed to be a downward direction and its opposite direction is assumed to be an upward direction.

A vibration device of the present embodiment has a semiconductor device including a drive circuit provided on a first surface that is an active surface of the semiconductor substrate. For reducing the size of the vibration device, the vibration element is provided superposed over the first surface where the drive circuit element is located. The vibration element in accordance with the present embodiment is described below.

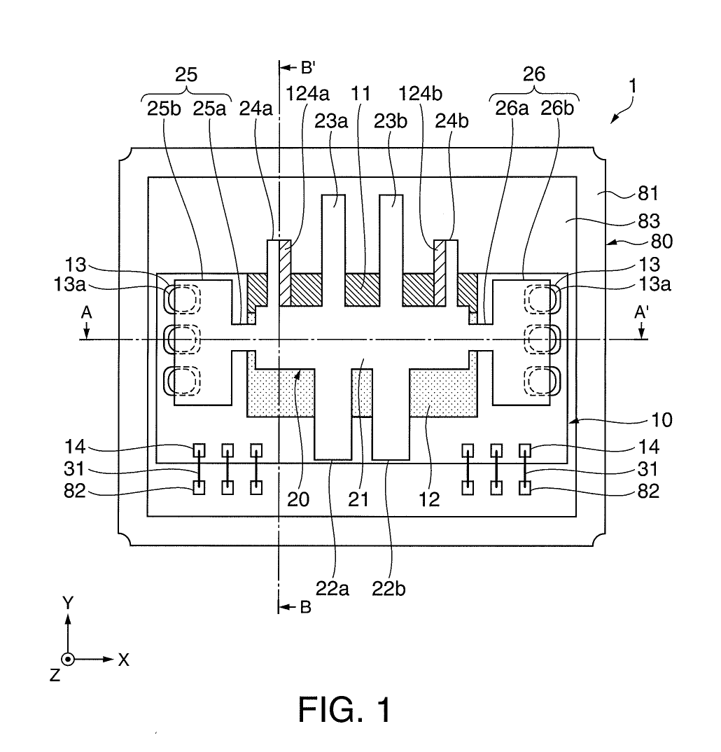

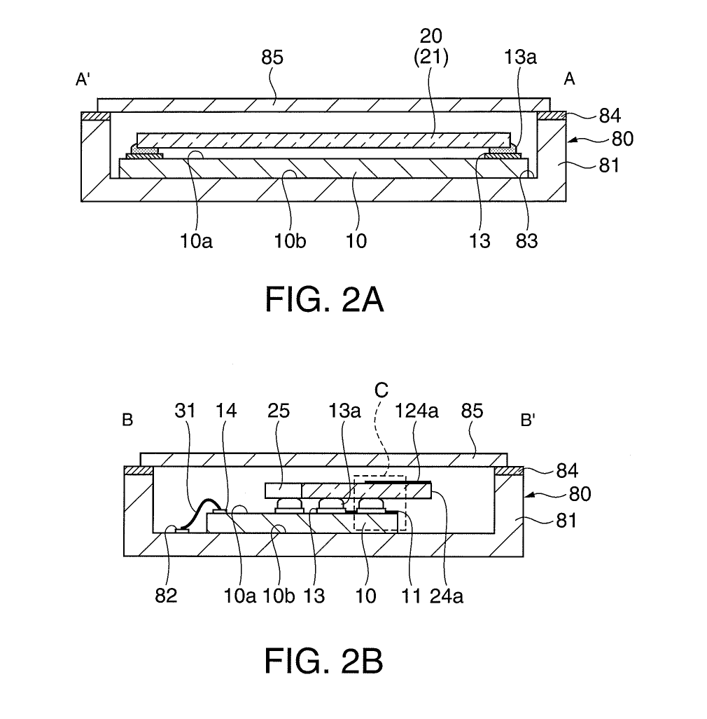

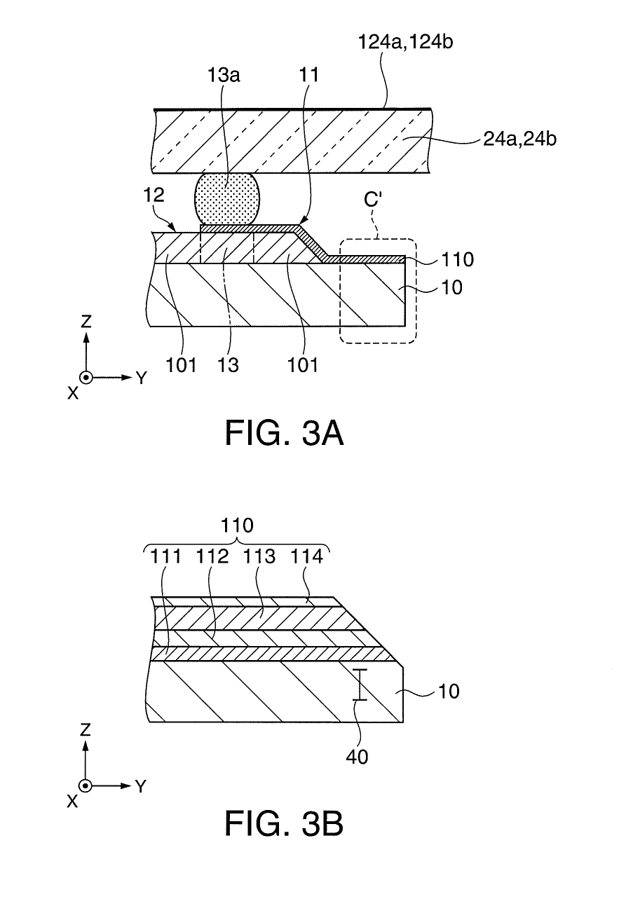

FIG. 1 and FIGS. 2A and 2B are views schematically showing the configuration of a vibration device 1 in accordance with an embodiment of the embodiment. FIG. 1 is a plan view of the vibration device 1 as viewed in Z axis direction. FIGS. 2A and 2B are cross-sectional views of the vibration device shown in FIG. 1. FIG. 2A is a cross-sectional view taken along a line A-A shown in FIG. 1 as viewed in Y axis direction. Also, FIG. 2B is a cross-sectional view taken along a line B-B shown in FIG. 1 as viewed in X axis direction. FIGS. 3A and 3B are enlarged cross-sectional views of a semiconductor substrate. More specifically, FIG. 3A is an enlarged cross-sectional view of an end section of the semiconductor substrate that forms the vibration device shown in FIG. 1. Also, FIG. 3B is an enlarged cross-sectional view a protective layer provided on the semiconductor substrate.

The vibration device in accordance with the present embodiment is equipped with a semiconductor substrate 10, a vibration element 20 and a base substrate 80, as shown in FIG. 1 and FIGS. 2A and 2B.

### Configuration of Vibration Element

The vibration element 20 of the embodiment is formed from quartz crystal that is a piezoelectric material as a base material (a material that composes the main portion thereof). Quartz crystal has X axis that is called an electric axis, Y axis that is called a mechanical axis, and Z axis that is called an optical axis. In the present embodiment, an example that uses a quartz Z-plate is described. The quartz Z-plate is formed by cutting quartz crystal along a plane defined by the X axis and the Y axis orthogonal to each other in the crystal axis of the quartz crystal, and processing the same into a plate shape, having a predetermined thickness in the Z axis direction orthogonal to the plane. The predetermined thickness is suitably set depending on the oscillation frequency (resonance frequency), the external size, the processability, etc. Also, as for the plate forming the vibration element 20, some errors from the cut angle of crystal quartz can be allowed for each of the X axis, Y axis and Z axis to some degree. For example, it is possible to use a plate that is cut with a cut angle rotated within 0 degree to 2 degrees from the X axis. This similarly applies to the Y axis and Z axis. Though the vibration element 20 of the embodiment uses quartz crystal, other piezoelectric materials (for instance, lithium tantalate, lead zirconate titanate, etc.) may be used as the base material.

The vibration element 20 is formed by etching using a photolithography technique (wet etching or dry etching). Note that plural vibration elements 20 can be cut from one crystal quartz wafer.

The vibration element 20 of the embodiment has a configuration called an H-type. The vibration element 20 has a base 21, vibration arms for driving 22a and 22b as a vibration section, vibration arms for detection 23a and 23b, and vibration arms for adjustment 24a and 24b, formed in one piece through processing the base material. Also, a first support section 25 is formed from a first connection section 25a extending from the base section 21, and a first fixed section 25b as a second electrode that is connected to the first connection section 25a and fixed to the semiconductor substrate 10. A second support section 26 is formed from a second connection section 26a extending from the base section 21, and a second fixed section 26b as a second electrode that is connected to the second connection section 26a and fixed to the semiconductor substrate 10.

On the vibration arms for adjustment 24a and 24b of the vibration element 20, electrodes for adjustment 124a and 124b are formed as mass adjustment sections. Moreover, the electrodes for adjustment 124a and 124b are used for adjusting the frequency of the vibration elements 20. The frequency adjustment may be performed by a method of irradiating a laser beam to the vibration arms for adjustment 24a and 24b, or the like, thereby removing a portion of the electrodes for adjustment 124a and 124b to change (reduce) the mass thereof and to change (increase) the frequency of the vibration arms for adjustment 24a and 24b, whereby the frequency is adjusted to a desired frequency (details will be described later).

Detection electrodes (not shown in the drawings) are formed on the vibration arms for detection of the vibration element 20. Also, drive electrodes (not shown in the drawings) are formed on the vibration arms for driving 22a and 22b. In the vibration element 20, the vibration arms for detection 22a and 22b form a detection vibration system that detects angular velocity, etc., and the vibration arms for driving 22a and 22b and the vibration arms for adjustment 24a and 24b form a drive vibration system that drives the vibration element 20.

### Configuration of Semiconductor Substrate

As shown in FIG. 1 and FIGS. 2A and 2B, the semiconductor substrate 10 has an active area 12 in an active surface 10a defining a first surface of the semiconductor substrate 10, where active elements (not shown) such as semiconductor elements including transistors, memory elements and the like (not shown), integrated circuits including circuit wirings, and the like are formed.

A portion of the active area 12 shown filled with dots (shaded with dots) is provided in the active surface 10a of the semiconductor substrate 10 which does not overlap the vibration arms for adjustment 24a and 24b, and the electrodes for adjustment 124a and 124b, when the vibration device 1 is viewed in a plan view. The active elements formed in the active area 12 include a drive circuit for driving and vibrating the vibration element 20, and a detection circuit for detecting detected vibration caused in the vibration element 20 when an angular velocity, etc. is applied.

Moreover, an end section on the side of the active surface 10a of the semiconductor substrate 10 has a protection area 11. The protection area 11 includes an end section that is a part of an area between the outer periphery (edge) of the semiconductor substrate 10 and the active area 12. A portion of the protection area 11 that is shown with hatching (slanted lines) in FIG. 1 includes an end section of the semiconductor substrate 10, as viewed in a plan view of the vibration device 1, on the side of the active surface 10a of the semiconductor substrate 10 which overlap the electrodes for adjustment 124a and 124b. A protective layer 110 is provided in the protection area 11. The protective layer 110 includes the edge of the semiconductor substrate 10 and is provided generally in the same range as the protection area 11.

When the laser beam is irradiated to the electrodes for adjustment 124a and 124b for adjusting the frequency, and when the laser beam penetrates the vibration element 20 and reaches the active surface 10a, the semiconductor substrate 10 can be protected by the protective layer 110 along with its disappearance (removal). In this manner, damage to the active elements installed in the active area 12 can be controlled by the protective layer 110 being installed.

Moreover, a stress relieving layer 101 (its illustration omitted in FIGS. 1, 2A and 2B) is provided on the active surface 10a, for relieving stress caused between the semiconductor substrate 10 and the vibration element 20 by thermal expansion (contraction).

### Structure of Protective Layer

The protective layer 110 is described with reference to FIGS. 3A and 3B. FIG. 3A is schematic enlarged view showing a portion encircled by a dotted line indicated by a sign C in FIG. 2B. FIG. 3B is schematic and further enlarged view of a portion near the edge of the semiconductor substrate 10 (a portion encircled by a dotted line indicated by a sign C′) in FIG. 3A.

The protective layer 110 is provided at the edge section on the active surface 10a defining the first surface of the semiconductor substrate 10. The protective layer 110 is composed of plural films of metal materials. The protective layer 110 is provided in a manner to cover the edge section of the semiconductor substrate 10, as shown in FIG. 3A. Moreover, as described above, when the vibration device 1 is viewed in a plan view, the protective film 110 is provided in a manner to overlap the electrodes for adjustment 124a and 124b.

The protective layer 110 has plural protective layers (films), as shown in FIG. 3B. In the embodiment, the protective layer 110 includes a first protective layer 111, a second protective layer 112, a third protective layer 113, and a fourth protective layer 114.

The first protective layer 111 is provided on the semiconductor substrate 10 or on the surface of the stress relieving layer 101 provided on the semiconductor substrate 10 (in the Z axis direction shown in FIG. 3B). Next, the second protective layer 112 is provided on the surface of the first protective layer 111 (in the Z axis direction shown in FIG. 3B). The third protective layer 113 is provided on the surface of the second protective layer (in the Z axis direction shown in FIG. 3B). The fourth protective layer 114 is provided on the surface of the third protective layer 113 (in the Z axis direction shown in FIG. 3B).

The first protective layer 111 of the embodiment is a layer (film) made of titanium tangsten (TiW) as a constituting material having a thickness of about 0.3 micrometer.

The second protective layer 112 of the embodiment is a layer (film) made of copper (Cu) as a constituting material having a thickness of about 0.2 micrometer.

The third protective layer 113 of the embodiment is a layer (film) made of copper (Cu) as a constituting material having a thickness of about 8 micrometer.

The fourth protective layer 114 of the embodiment is made of layers (films) of nickel (Ni), palladium (Pd) and gold (Au) as constituting materials sequentially provided in this order on the surface of the third protective layer 113. The nickel layer may be formed in a thickness of about 0.25-0.3 micrometer, the palladium layer in a thickness of about 0.05-0.35 micrometer, and the gold layer in a thickness of 0.02 micrometer or greater.

Note that the structure of the protective layer 110 described above is an example, and its structure and constituting materials may be suitably changed according to the irradiation condition of the laser used in a frequency adjustment step S600 (to be described below).

### Configuration of Electrode

The semiconductor substrate 10 has first electrodes 13 provided on the side of the active surface 10a. The first electrodes 13 are conductively, directly connected to the integrated circuit provided on the semiconductor substrate 10. Moreover, a first insulation film that becomes a passivation film (not shown in the figure) is formed on the active surface 10a. In the first insulation film, opening sections (not shown in the figure) are formed over the first electrodes 13. According to such a configuration, the first electrodes 13 are exposed to the outside in the openings.

The first electrodes 13 provided on the semiconductor substrate 10 are exposed inside opening sections (not shown in the figure) of the first insulation film (not shown in the figure) and the stress relieving layer 101, as shown in FIG. 3A, and external connection terminals 13a are installed on the first electrodes 13. The external connection terminals 13a are formed from, for example, protruded electrodes made of Au stud bumps. The first connection electrodes 13a can be formed with other electroconductive materials, such as, copper, aluminum, solder balls, etc. besides the Au stud bumps. Also, the first connection electrodes 13a can be formed with electroconductive adhesive that mixes electroconductive filler, such as, silver powder, copper powder, etc. and synthetic resin, etc.

According to such a composition as described above, the semiconductor substrate 10 and the vibration element 20 are connected in such a manner that the first electrodes 13 and the external connection terminals 13a formed on the semiconductor substrate 10 are electrically connected with the first fixed section 25b and the second fixed section 26b as the second electrodes provided on the vibration element 20. In this instance, in the vibration device 1, as the external connection terminals 13a are formed from protruded electrodes, a gap is created between the semiconductor substrate 10 and the vibration element 20.

Moreover, other electrodes (not shown in the figure) besides the first electrodes 13 may be provided on the integrated circuit installed on the semiconductor substrate 10. These other electrodes are connected with wirings (not shown in the figure), and connected with wiring terminals 15 through these wirings. Note that the wiring terminals 14 may be provided in the form of pads for electrical or mechanical connection, and are connected with the base substrate 80 through wires 31 such as bonding wires that use metal, such as, for example, gold (Au), aluminum (Al) or the like. Note that the present example has been described, referring to the composition that uses the wirings 31 to connect the wiring terminals 14 and the base substrate 80. However, a flexible wiring substrate (FPC: Flexible Printed Circuits) may be used for connection instead of the wirings 31.

### Guard Ring

A guard ring 40 is provided in the semiconductor substrate 10, as shown in FIG. 3B. The guard ring 40 is installed between the edge of the semiconductor substrate 10 and the active area 12 in a manner to encircle the active area 12. When the laser beam used in the frequency adjustment process 5600 to be described later is irradiated to the protective layer 110, the guard ring 40 can control transmission of heat and the like generated when the protective layer 110 melts (disappears) or when the laser beam reaches the semiconductor substrate 10. Moreover, the guard ring 40 controls transmission of moisture from the outside of the semiconductor substrate 10 to the active elements, whereby the moisture-resistant property of the semiconductor substrate 10 can be improved. In the embodiment, the guard ring 40 may preferably be formed from metal material. The guard ring 40 may be formed from metal, such as, for example, aluminum (AL), tungsten (W), copper (Cu), etc., and other material, such as, polysilicon, etc.

### Base Substrate

Referring back to FIGS. 1, 2A and 2B, the base substrate 80 that composes the vibration device 1 is described. The base substrate 80 shown in FIGS. 1, 2A and 2B has a bottom surface 83 that is bonded (connected) with a surface (a non-active surface 10b) of the semiconductor substrate 10 on the opposite side of the active surface 10a with a bonding member such as adhesive (not shown).

The base substrate 80 is formed from a nonconductive material, such as, ceramics, for example. On the bottom surface 83 of the base substrate 80 where the semiconductor substrate 10 is bonded, connection sections 82 are formed. Metal films made of gold (Au), silver (Ag) or the like are provided on the connection sections 82. Moreover, the connection sections 82 on the base substrate 80 and the wiring terminals 14 provided on the semiconductor substrate 10 are connected through wires 31. Note that the connection sections 82 are connected with external terminals provided on the based substrate 80 through wirings (not shown in the figure).

The base substrate 80 may use a package having a concave space in the center section thereof (an accommodation container) having a side wall 81 at its circumference.

The semiconductor substrate 10 and the vibration element 20 accommodated in the base substrate 80 (package) are sealed airtight by a metal lid defining a lid 85 to be bonded to the opened surface at the side wall 81 of the package through a seal ring 84.

### Arrangement of Vibration Element

The vibration element 20, when viewed in a plan view of the vibration device 1, is arranged on the side of the active surface 10a of the semiconductor substrate 10 in a manner that it is superposed over the semiconductor substrate 10. Also, the vibration element 20 is arranged in a position where the electrodes for adjustment 124a and 124b provided on the vibration arms for adjustment 24a and 24b are superposed over the protective layer 11 arranged in the active surface 10a.

As described above, the vibration element 20 is mounted on the semiconductor substrate 10 in a manner that the first electrodes 13 and the external connection terminals 13a provided on the semiconductor substrate 10 are connected with the first fixed section 25b and the second fixed section 26b provided as the second electrodes on the vibration element 20.

Note that when the electrodes for adjustment 124a and 124b are provided in an area that does not overlap the semiconductor substrate 10, the laser beam, that penetrates the vibration arms for adjustment 24a and 24b in the frequency adjustment process S600 to be described later, will be irradiated to the bottom surface 83 of the base substrate 80. The base substrate 80 of the vibration device 1 of the embodiment is formed with material, such as, ceramics, etc., as described above, and would much less likely be melted by irradiation of the laser beam, compared to the case where the laser beam is irradiate to the semiconductor substrate 10. Therefore, the protective layer 110 is provided in the area where the electrodes for adjustment 124a and 124b and the semiconductor substrate 10 do not overlap each other.

### Operation of Vibration Element

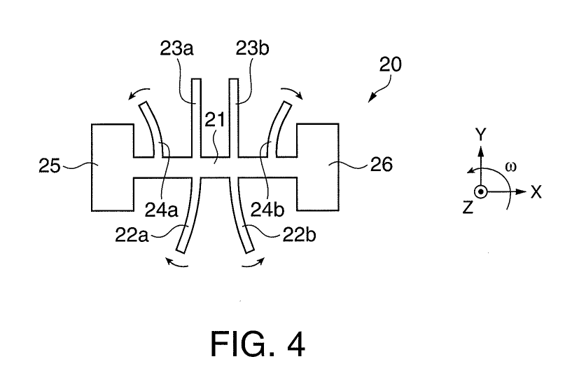

The operation of the vibration element 20 that is mounted on the vibration device 1 will be described below. FIG. 4 is an illustration showing the operation of the vibration element 20 that composes the vibration device 1.

First, when an excitation drive signal is impressed to the vibration element 20 from the drive circuit provided in the semiconductor device 10. While the vibration arms for driving 22a and 22b impressed with a predetermined excitation drive signal is in the state of vibration, if an angular velocity ω around the Z axis is applied to the vibration element 20, the Coriolis force is generated in the vibration arms for detection 23a and 23b. The vibration arms for adjustment 24a and 24b are excited by the vibration of the vibration arms for detection 23a and 23b. Then, the detection electrodes (not shown in FIG. 1) provided on the vibration arms for detection 23a and 23b detect deformation of crystal quartz (a piezoelectric material) that is the base material of the vibration element generated by the vibration, whereby the vibration device 1 obtains the angular velocity.

### Method for Manufacturing Sensor Device

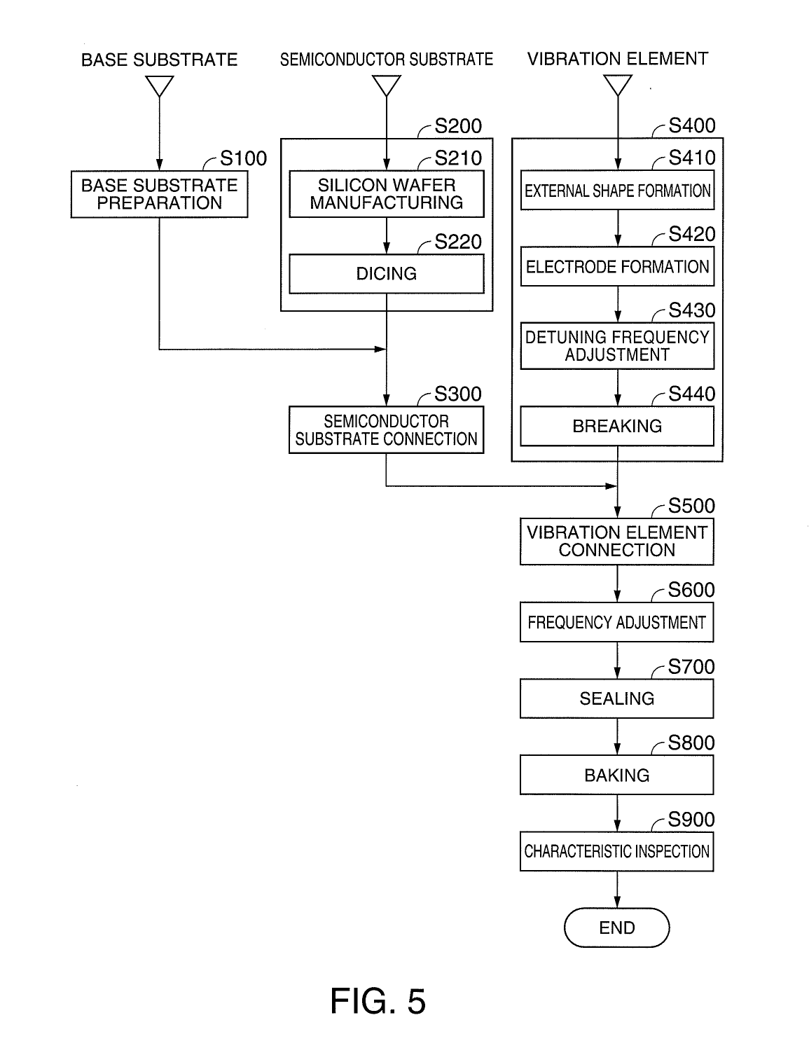

A method for manufacturing the vibration device 1 in accordance with an embodiment will be described below. According to the method for manufacturing the vibration device 1, in the present embodiment, a package having a concave portion is used as the base substrate 80, and the vibration device 1 is bonded within the package and sealed by the lid member 85. FIG. 5 is a flow diagram (flow chart) showing the process of manufacturing a vibration device 1.

As shown in FIG. 5, the method for manufacturing the vibration device 1 includes a base substrate preparation process S100, a semiconductor substrate formation process S200, a semiconductor substrate connection process S300, a vibration element formation process S400, a vibration element connection process S500, a frequency adjustment process S600, a sealing process S700, a baking process S800, and a characteristic inspection process S900.

### Base Substrate Preparation Process

The base substrate preparation process S100 is a process of preparing a base substrate 80. In the base substrate preparation process S100, the base substrate 80 that may be formed from ceramics or the like is prepared. Note that a connection section 82 for electrical connection with the semiconductor substrate 10 is formed on a bottom surface 83 that is one surface of the base substrate 80.

### Semiconductor Substrate Formation Process

The semiconductor substrate formation process S200 is a process of forming a semiconductor substrate 10 equipped with a vibration element 20. The semiconductor substrate formation process S200 includes a silicon wafer manufacturing process S210 and a dicing process S220. The silicon wafer manufacturing process S210 uses the semiconductor manufacturing process to form plural semiconductor substrates 10 equipped with active elements in bulk in a silicon wafer. In this process, first electrodes 13, wiring terminals 14 and other electrodes (not shown in the figure) are formed at positions that become conduction sections of each integrated circuit on the active surface 10a of each of the semiconductor substrates 10 formed in the silicon wafer. Moreover, a stress relieving layer 101 and a protective layer 110 are formed on the side of the active surface 10a of the semiconductor substrate 10.

In the silicon wafer manufacturing process S210, the stress relieving layer 101 and a first insulation film (not shown in the figure) are formed on the semiconductor substrate 10. Next, a part of the stress relieving layer 101 and the first insulation film is removed by a photolithography method and an etching method, thereby forming opening sections. As a result, the first electrodes 13, the other electrodes, and the wiring terminals 14 are exposed in these openings. Nickel (Ni) and gold (Au) are plated on the surface of the wiring terminals 14, whereby the bondability in wire bonding is improved. Note that surface treatment such as solder plating and solder pre-coating may be applied to the wiring terminals 14.

The silicon wafer manufacturing process S210 also forms the protective layer 110. The protective layer 110 of the embodiment is composed of four layers from the first protective layer 111 to the fourth protective layer 114. For the first protective layer 111, a layer (film) of titanium tungsten (TiW) having a thickness of about 0.1 micrometer is formed by a sputtering method. The film forming material and the thickness of the first protective layer 111 may be suitably changed depending on the film forming material to be selected for the second protective layer 112, adhesion with the material to be selected for the semiconductor substrate 10 and the stress relieving layer 101, and the like.

Next, the silicon wafer manufacturing process S210 forms the second protective layer 112. For the second protective layer 112, a layer (film) of copper (Cu) having a thickness of about 0.3 micrometer is formed by a sputtering method, similarly to the first protective layer 111. The film forming material and the thickness of the second protective layer 112 may be suitably changed depending on the film forming material selected for the first protective layer 111, adhesion with the material to be selected for the third protective layer 113, and the like.

Next, the silicon wafer manufacturing process S210 forms the third protective layer 113. For the third protective layer 113, a resist film is formed by a photolithography method in portions other than the protection area 11 where the third protective layer 113 is formed. For the third protective layer 113, a plated layer (film) of copper (Cu) having a thickness of about 8 micrometer is selectively formed by an electrolysis plating method in areas where the resist film is not formed, in other words, in the protection area 11 where the second protective layer 11 is exposed. The film forming material and the thickness of the third protective layer 113 may be suitably changed depending on the thickness of the protective layer 110 that disappears when the laser beam reaches the protective layer 110, which may be determined by the intensity of the laser beam used in the frequency adjustment process 5600, and the exposure time.

Next, the silicon wafer manufacturing process S210 forms the fourth protective layer 114. As for the formation of the fourth protective layer 114, layers (films) of nickel (Ni), palladium (Pd) and gold (Au) are formed in this order by an electroless plating method. In the present embodiment, the electroless plating method is used to form the fourth protective layer 114, by which the nickel layer is formed to a thickness of about 0.25-0.3 micrometer, the palladium layer to a thickness of about 0.05-0.35 micrometer, and the gold layer to a thickness of 0.02 micrometer of greater. Because gold (Au) is used for an electrode (not shown in the figure) formed on the fourth protective layer 114, the fourth protective layer 114 is provided with a nickel-palladium-gold composition. However, the film forming material of the fourth protective layer 114 may be suitably changed depending on the electrode to be formed. Although the fourth protective layer 114 is formed by using an electroless plating method in the example described above, the fourth protective layer 114 may be formed by electrolytic plating.

Moreover, a guard ring 40 is formed in the silicon wafer manufacturing process S210. The guard ring 40 is formed in a manner similar to the active element described above, and is provided to encircle the active area 12 where active elements are disposed. The guard ring 40 is provided to protect the active elements from heat caused when the laser beam used in the frequency adjustment process 5600 to be described later is irradiated to the protective layer 110, and the protective layer 110 disappears.

Moreover, the protective layer 110 that is provided in an edge area of the semiconductor substrate 10 has a slope as it is cut (opened) by a bevel cutting method in the dicing process S220 to be described later. Therefore, the protective layer 110 in the portion having the slope is thinner compared with other portions. When a laser beam is irradiated to the thinned portion of the protective layer 110, the protective layer 110 disappears, and the laser beam may reach the semiconductor substrate 10, generating heat. The guard ring is provided to protect active elements from the generated heat.

Therefore, the guard ring 40 is provided in the area where the semiconductor substrate 10 would not be exposed even if the protective layer 110 disappears when the laser beam used in the frequency adjustment process 5600 penetrates the vibration arms for adjustment 24a and 24b (the vibration element 20) and is irradiated to the protective layer 110. Concretely, the laser beam used in frequency adjustment process S600 is irradiated to the protective layer 110 for instance. More specifically, for example, when the laser beam used in the frequency adjustment process S600 is irradiated to the protective layer 110, and the protective layer 110 disappears by a thickness of 2 micrometer, the guard ring 40 is provided in an area where the protective layer 110 has a thickness more than 2 micrometer, and between the edge section of the semiconductor substrate 10 and the active area 12 where active elements are formed.

Moreover, the silicon wafer manufacturing process 5210 forms external connection terminals 13a formed with Au stud bumps on the first electrodes 13. The external connection terminals 13a can be formed with other electroconductive materials, such as, copper, aluminum (Al), solder balls, and solder paste, besides the Au stud bumps.

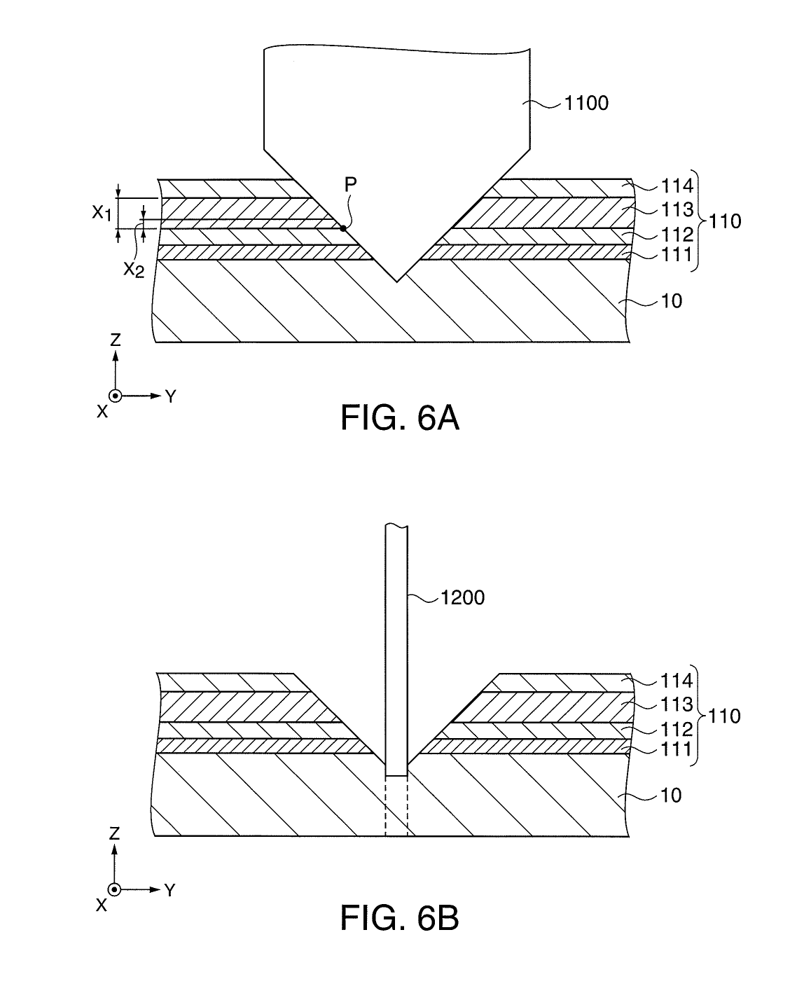

The dicing process S220 is a process of dividing semiconductor substrates 10 that are formed in plurality in the silicon wafer into individual pieces. FIGS. 6A and 6B schematically show enlarged views of the edge section of the semiconductor substrate 10. FIG. 6A schematically shows the state where the protective layer 110 is cut (opened) by a bevel cutting method. First, in the dicing process S220, by using the bevel cutting method, the protective layer 10 is cut, and then a part of the semiconductor substrate 10 is cut (half-cut). Then, by using a rotary blade 1200, the semiconductor substrate 10 is cut.

In the bevel cutting that cuts (opens) the protective layer 110, a V-shaped blade 1100 is pressed against the protective layer 110 and the semiconductor substrate 10 that are objects to be cut, thereby cutting the protective layer 110 and the semiconductor substrate 10 in the same V-shape as that of the blade 1100.

In this instance, thermal expansion corresponding to the force to which the blade 1100 is pressed is caused in the first protective layer 111 through the fourth protective layer 114 that compose the protective layer 110, and stress concentrates at a portion of the protective layer 110 that comes in contact with the blade 1100 and is cut (sheared). The stress occurs according to the thickness of the protective layer 110 to be sheared, and the stress becomes smaller as the thickness of the protective layer 110 to be cut becomes thinner. For example, the thermal expansion caused at the time of cutting is about the same level in a portion of the third protective layer 113 where the thickness of the third protective layer 113 is X1 and in a portion where the thickness is X2. However, the stress generated when the third protective layer 113 is cut concentrates on a point P shown in FIG. 6A. The point P on which the stress concentrates is at the interface with the second protective layer 112, where the third protective layer 113 would most likely be peeled off. Therefore, by using the bevel cutting method, the stress by the thermal expansion decreases as the thickness of the third protective layer 113 to be cut becomes thinner, and exfoliation at the interface with the second protective layer 112, and particularly at the point P where the stress concentrates, can be suppressed. By cutting the protective layer 110 by the bevel cutting method, exfoliation to be caused by cutting the first protective layer 111 to the fourth protective layer 114 can be controlled, similarly to the third protective layer 113 described above. Moreover, by forming the first protective layer 111 by electroless plating, adhesion with the second protective layer 112 can be improved, and exfoliation of the first protective layer 111 that is open on one surface side thereof and would most readily peel off can be controlled. Further, by cutting the protective layer 110 by the bevel cutting method, exfoliation of the protective layer 110 formed in the silicon wafer manufacturing process S210 at the end section of the semiconductor substrate 10 due to thermal stress generated after the cutting can be controlled.

Next, in the dicing process S220, a rotary blade 1200 is inserted in a portion where the semiconductor substrate 10 is exposed after the protective layer 110 and a portion of the semiconductor substrate 10 have been cut open by the bevel cutting method, thereby cutting the semiconductor substrate 10. FIG. 6B is a schematic illustration of the state where the rotary blade 1200 is brought in direct contact with the semiconductor substrate 10 to cut the semiconductor substrate 10. When the semiconductor substrate 10 is cut, the rotary blade 1200 can be brought in direct contact with the semiconductor substrate 10 that is an object to be cut, and contact to the protective layer 110 can be suppressed. Therefore, cutting and exfoliation of the protective layer 110 that may be caused by contact and friction between the rotary blade 1200 and the protective layer 110 can be suppressed. Therefore, exfoliation of the protective layer 110 at the edge section of the semiconductor substrate 10 can be suppressed.

### Semiconductor Substrate Connection Process

The semiconductor substrate connection process S300 is a process of connecting the semiconductor substrate 10 on the side of the non-active surface 10b to the bottom 83 of the base substrate 80 through a bonding material, such as, adhesive (not shown in the figure). Moreover, in the semiconductor substrate connection process S300, the wiring terminals 14 on the semiconductor substrate 10 are connected with the connection sections 82 on the base substrate 80 by using bonding wires 45 by a wire bonding method.

### Vibration Element Formation Process

The vibration element formation process S400 is a process of forming a vibration element 20. The vibration element formation process S400 includes an external shape formation process S410, an electrode formation process S420, a detuning frequency adjustment process S430, and a breaking process S440. Vibration elements 20 can be formed in plurality by using a wafer for vibration element (not shown in the figure).

First, the external shape formation process S410 is a process of forming an external shape of a plurality of vibration elements 20 by etching a wafer for vibration element, using a photolithography technique. Next, the electrode formation process S420 is a process of forming electrodes such as drive electrodes and detection electrodes and wirings to the vibration element 20 by sputtering and vapor deposition, using a photolithography technique. In this electrode formation process S420, electrodes for adjustment 124a and 124b as mass adjustment sections are formed on the vibration arms for adjustment 24a and 24b, detections electrodes (not shown) are formed on the vibration arms for detection 23a and 23b, and drive electrodes (not shown) are formed on the vibration arms for driving 22a and 22b.

### Detuning Frequency Adjustment Process

The detuning frequency adjustment process S430 is a process of adjusting the detuning frequency of the vibration element 20 by using a laser beam. In the detuning frequency adjustment process S430, the difference in flexural vibration frequency between the vibration arms for adjustment 24a and 24b and the vibration arms for driving 22a and 22b is detected, and balance adjusting (tuning) is performed to correct the difference. This can be done in the state of the wafer for vibration element. In other words, the detuning frequency adjustment process S430 can be performed before the breaking process S440 to be described later.

The tuning is performed through irradiating a focused laser beam at the adjustment electrodes 124a and 124b provided on the vibration arms for adjustment 24a and 24b. When the laser beam is irradiated to the adjustment electrodes 124a and 124b, a part of them melts and evaporates by the energy of the laser beam. The vibration arms for adjustment 24a and 24b change their mass as the adjustment electrodes 124a and 124b melt and evaporate. As a result, because the resonance frequency of the vibration arms for driving 22a and 22b with respect to the vibration arms for adjustment 24a and 24b changes, the balance of each of the vibration arm can be adjusted (tuned). After the vibration element 20 is mounted on the semiconductor substrate 10, tuning is performed again in the frequency adjustment process 600.

### Vibration Element Breaking Process

The breaking process S440 is a process of breaking (cutting) the wafer for vibration element, thereby performing singulation to obtain separated pieces of vibration elements 20. For the singulation, perforated lines or grooves may be formed in portions of the external shapes of the vibration elements 20 in the wafer for vibration element at connection parts in the external shape formation process S410, and the wafer can be broken along the perforated lines or the grooves.

### Vibration Element Connection Process

The vibration element connection process S500 is a process of mounting the vibration element 20 on the semiconductor substrate 10, and connecting the first electrodes 13 of the semiconductor substrate 10 with the first fixed section 25b and the second fixed section 26b of the vibration element 20 through the external connection terminals 13a.

### Frequency Adjustment Process

The frequency adjustment process 5600 is a process of adjusting the frequency (balance tuning) of the vibration element 20 by using a laser beam. The balance tuning is performed by irradiating a focused laser beam to the electrodes for adjustment 124a and 124b installed on the vibration arms for adjustment 24a and 24b of the vibration element 20, similarly to the detuning frequency adjustment process S430 described above. The electrodes for adjustment 124a and 124b, upon being irradiated with the laser beam, melt and evaporate by the energy of the laser beam, and the vibration arms for adjustment 24a and 24b change their resonance frequency due to the change in mass, whereby the balance adjustment (tuning) on the vibration arms for driving 22a and 22b can be performed. More specifically, in the frequency adjustment, when the vibration arms for driving 22a and 22b are excited and vibrated in the state in which no acceleration is applied to the vibration device 1 (the vibration element 20), the mass of the adjustment electrodes 124a and 124b as mass adjustment sections provided on the vibration arms for adjustment 24a and 24b is adjusted in a manner that the vibration arms for detection 23a and 23b do not vibrate.

In this instance, the laser beam that melted and evaporated the adjustment electrodes 124a and 124b may penetrate the vibration element 20. However, according to the configuration of the embodiment, the vibration element 20 is mounted in a manner that, in the active surface 10a of the semiconductor substrate 10, the electrodes 124a and 124b and the protection area 11 where the protective layer 110 is formed overlap each other. As a result, when the laser beam penetrates the vibration arms for adjustment 24a and 24b (the vibration element 20), the laser beam is irradiated to the protective layer 110, and the protective layer 110 melts, whereby melting of the integrated circuit that contains active elements and wirings and thus damage of its characteristic can be avoided.

Moreover, there may be cases where the laser beam used in the frequency adjustment process 5600 may be irradiated to the adjustment electrodes 124a and 124b located in an area where the thickness of the protective layer 110 is thinner than the thickness of the portion of the protective layer 110 to be removed by the laser beam. In this instance, the laser beam penetrates the vibration element 20 where the adjustment electrodes 124a and 124b are installed and is irradiated to the protective layer 110. Even when the laser beam removes the protective layer 110, and reaches the semiconductor substrate 10, the guard ring 40 can protect the active elements installed in the semiconductor substrate 10 from damage due to heat generated by the laser beam.

### Sealing Process

The sealing process 5700 is a process of sealing the concave portion of the base substrate 80 to which the semiconductor substrate 10 and the vibration element 20 are connected by connecting the lid member 85 as a lid on the base substrate 80 (package). For example, the sealing process 5700 can connect a metal lid (the lid member 85) by seam welding through a seal ring 84 consisting of iron (Fe)—nickel (Ni) alloy, etc. At this time, the cavity formed by the concave portion of the base substrate 80 and the lid may be provided with a reduced pressure space or an inert gas atmosphere if necessary and sealed up. Moreover, as other methods of connecting the lid (the lid member 85), it is possible to connect the lid on the base substrate 80 through a metal brazing material such as solder or the like, or it is possible to use a glass lid (a lid member 85), and connect the lid to the base substrate 80 with low melting-point glass or the like.

### Baking Process and Characteristic Inspection Process

The baking process S800 is a process for baking in which the vibration device 1 is placed in an oven at a predetermined temperature for a predetermined period of time to remove moisture contained in the vibration device 1. Furthermore, the characteristic inspection process S900 is a process of performing characteristic inspections, such as, electric characteristic inspection, external appearance inspection, etc., and removing non-standard defective products. A series of processes for manufacturing the vibration device 1 is completed, when the characteristic inspection process 5900 is completed.

The following effects can be obtained by the embodiment described above. According to the vibration device 1, as seen in a plan view, the vibration element 20 is installed on the semiconductor substrate 20 in a manner that the adjusting electrodes 124a and 124b as mass adjusting sections overlap the protective layer 110 provided in the end section of the semiconductor substrate 10. Also, a portion of the vibration element 20 does not overlap the semiconductor substrate 10, in other words, the vibration arms for adjustment 24a and 25b and the vibration arms for detection 23a and 23 have overhangs (extend outward) beyond the edge section of the semiconductor substrate 10. As a result, the area of the semiconductor substrate 10 can be reduced by an amount corresponding to the overhanging surface area of the vibration element 20, compared with the vibration device of related art in which the vibration element is mounted on the semiconductor substrate.

According to the vibration device 1 described above, in a cross-sectional view of the end section of the semiconductor substrate 10, the protective layer 110 covering the end section of the semiconductor substrate 10 is formed to have a slope such that its thickness becomes smaller toward the edge of the semiconductor substrate 10. As a result, exfoliation between the semiconductor substrate 10 and the protective layer 110 or among the layers in the protective layer 110, which may be caused by stress generated when the protective layer 110 is cut (opened), can be suppressed. Also, as the protective layer 110 (the fourth protective layer 114) is formed by electroless plating, the vibration device can be equipped with a protective layer 110 that can suppress exfoliation between the semiconductor substrate 10 and the protective layer 110 or among the layers in the protective layer 110, which may be caused by stress generated by thermal expansion occurring after the protective layer 110 is cut. As a result, even when the protective layer 110 is provided at the end section of the semiconductor substrate 10, exfoliation of the protective layer 110 can be suppressed, and the active elements provided on the semiconductor substrate 10 can be protected from irradiation of the laser beam. Therefore, according to the vibration device 1, the semiconductor substrate can be miniaturized without changing the size of the vibration element. Moreover, due to the miniaturization, the number of semiconductor substrates 10 that can be obtained from one silicon wafer can be increased, such that vibration devices 1 with higher yield can be achieved.

According to the method for manufacturing a vibration device 1 described above, in the vibration element connection process S500 in which the vibration element 20 is mounted on the semiconductor substrate 10, the adjusting electrodes 124a and 124b as mass adjusting sections provided on the vibration element 20 overlap the protective layer 110 provided in the end section of the semiconductor substrate 10. Also, the vibration element 20 is mounted on the semiconductor substrate 10 in a manner that a portion of the vibration element 20 does not overlap the semiconductor substrate 10, in other words, has an overhang (extends outward) beyond the end section of the semiconductor substrate 10. As a result, even when a laser beam irradiated at the adjusting electrodes 124a and 124b as mass adjusting section of the vibration element 20 in the frequency adjustment process 5600 penetrates the vibration element 20, the laser beam is blocked by the protective layer 110 provided at the end section of the semiconductor substrate 10. Therefore, the area of the semiconductor substrate can be reduced by an amount corresponding to the overhanging surface area of the vibration element 20, compared with the vibration device of related art in which the vibration element is mounted on the semiconductor substrate.

Furthermore, according to the method for manufacturing a vibration device 1 described above, in the semiconductor substrate forming process S200, the protective layer 110 that covers the end section of the semiconductor substrate 10 is cut by a bevel cutting method. As a result, as seen in a cross-sectional view of the semiconductor substrate 10, the protective layer 110 that becomes thinner toward the edge of the semiconductor substrate 10 can be obtained. Accordingly, exfoliation between the semiconductor substrate 10 and the protective layer 110 and among the layers in the protective layer 110, which may be caused by stress generated when the protective layer 110 is cut, can be suppressed. Therefore, peeling of the protective layer 110 off from the edge of the semiconductor substrate 10 can be suppressed, such that the protective layer 110 can be formed at the end section of the semiconductor substrate 10. Also, in the semiconductor substrate formation process S200, the bevel cutting method is used to cut the protective layer 110 and a part of the semiconductor substrate 10, such that the rotary blade 1200 for cutting the semiconductor substrate 10 can be substantially prevented from contacting the cut protective layer 110. Accordingly, in the dicing process S220 in which the semiconductor substrate 10 is cut by the rotary blade 1200, exfoliation of the protective layer 110 and adhesion and re-scattering of metal composing the protective layer 110 can be suppressed.

Also, according to the method for manufacturing the vibration device 1 described above, there may be cases where the laser beam used in the frequency adjustment process S600 may be irradiated to the adjustment electrodes 124a and 124b as mass adjustment sections located in an area where the thickness of the protective layer 110 is smaller than the thickness of the portion of the protective layer 110 to be removed by the laser beam. In this instance, the laser beam penetrates the adjustment electrodes 124a and 124b and is irradiated to the protective layer 110. Even when the laser beam removes the protective layer 110, and reaches the semiconductor substrate 10, the guard ring 40 can protect the active elements installed in the semiconductor substrate 10 from damage due to heat, etc. generated by the laser beam.

Therefore, according to the method for manufacturing the vibration device 1 described above, the frequency adjustment process S600 using a laser beam which can suppress damage to the semiconductor substrate 10 can be performed at the end section of the semiconductor substrate 10 where the protective layer 110 becomes thinner. Further, according to the method for manufacturing the vibration device 1, the protective layer 110 is provided at the end section of the semiconductor substrate 10, such that the frequency adjustment process S600 can be performed on the vibration element 20 that is mounted in a manner extending beyond the semiconductor substrate 10.

What is claimed is:

1. A vibration device comprising:
a semiconductor substrate;
a first electrode provided on a first surface of the semiconductor substrate;
a protective layer provided on the first surface and covering an end section of the first surface; and
a vibration element having a vibration section, a mass adjusting section located on the vibration section and a second electrode,
the vibration element being mounted on the first surface with the first electrode and an external connection terminal being connected to the second electrode connected together, the mass adjusting section being located in an area that overlaps the protective layer in a plan view, and a part of the vibration element being disposed at a position that does not overlap the first surface in a plan view.

2. The vibration device according to claim 1, wherein the protective layer has a thickness that becomes smaller toward an end section of the semiconductor substrate.

3. The vibration device according to claim 1, wherein the protective layer is formed by electroless plating.

4. A method for manufacturing a vibration device including a vibration element having a vibration section and a mass adjustment section provided on the vibration section, and a semiconductor substrate having a first surface and a protective layer provided on the first surface and covering an end section of the first surface, the method comprising:
mounting the vibration element over the first surface;
positioning the mass adjustment section in an area that overlaps the protective layer in a plan view;
disposing a part of the vibration element at a position that does not overlap the first surface;
connecting a first electrode and an external connection terminal provided on the first surface to a second electrode of the vibration element; and
after mounting the vibration element, conducting frequency adjustment by adjusting the mass of the mass adjusting section through irradiating a laser beam at the mass adjusting section of the vibration element so that the vibration section of the vibration element has a specified value of resonance frequency.

5. The method for manufacturing a vibration device according to claim 4, further comprising forming the protective layer, and cutting the protective layer by a bevel cutting method.

6. The method for manufacturing a vibration device according to claim 4, wherein the protective layer is formed to have a thickness that becomes smaller toward the end section of the semiconductor substrate, and the frequency adjustment includes irradiating a laser beam at an area between the end section of the semiconductor substrate and a guard ring, as seen in a plan view, that is provided in the semiconductor substrate in a position where the protective layer having a thickness greater than a thickness of the protective layer to be removed by irradiation of the laser beam is located.
